(19) United States
(12) Patent Application Publication
(10) Pub. No.: US 2012/0081601 A1
(43) Pub. Date: Apr. 5, 2012

(54) Video over Internet to Multiple Display Devices

(75) Inventor: Christopher Carmichael, Irvine, CA (US)

(73) Assignee: UBIQUITY HOLDINGS, Irvine, CA (US)

(21) Appl. No.: 13/176,313

(22) Filed: Jul. 5, 2011

Related U.S. Application Data
(60) Provisional application No. 61/361,492, filed on Jul. 5, 2010.

(51) Int. Cl. H04N 7/01

(52) U.S. Cl. 348/441; 348/E07.003

(57) ABSTRACT

Video data is sent over a number of different channels in the TCP/IP format, and then converted. By sending the data in this format, bandwidth problems to the multiple users can be avoided.

This application claims priority from provisional application No. 61/361,492, filed Jul. 5, 2010, the disclosure of which is herewith incorporated by reference.

### BACKGROUND

Videos can be played over various media including over many different kinds of channels. For example, video is frequently played over the Internet. When played over the Internet, for example, the video may be decoded and displayed by a cell phone, portable video player, or any other kind of video device such as a conventional television or standalone media player.

### SUMMARY

An embodiment describes techniques by which a single video file or live video signal can be transmitted over the public Internet to multiple display devices from a remote location utilizing wireless IP technology.

### BRIEF DESCRIPTION OF THE DRAWINGS

in the drawings:

FIG. 1 shows a basic block diagram of the video system and its data path(s).

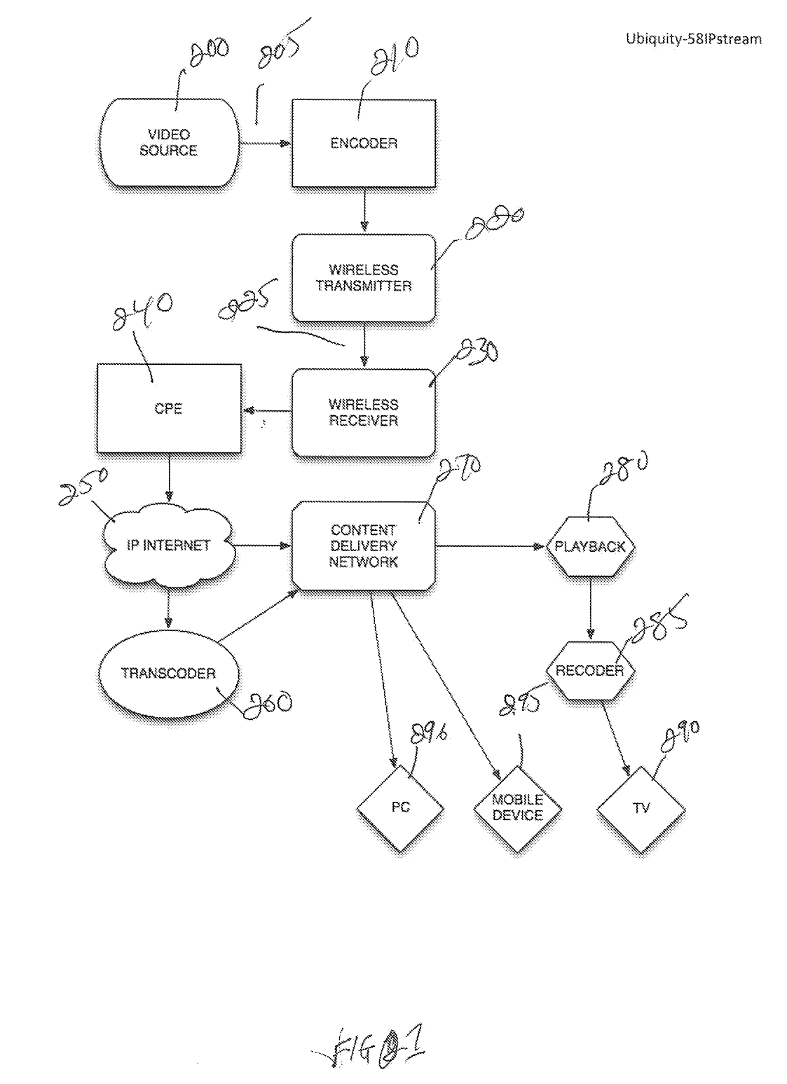

### DETAILED DESCRIPTION

In an embodiment, video is played over a media channel such as a television channel, a wireless communication channel such as a cell phone, or over the Internet. According to an embodiment, the video is played based on the received video information. The information which is sent over the channel 100 is received in a receiver 110 which can be a television tuner or computer or cell phone, or any other structure that can receive and/or play a video. The receiver 110 outputs a signal 115 that is displayed on the display 120, e.g., a video display or monitor. The receiver 110 may also operate according to a stored program, where that program can be executed by a processor 105 in the receiver. According to another embodiment, the receiver 110 is built into the display, for example similar to a stand-alone television set and its built-in receiver. The information from the channel is displayed on the screen 120. This may be a video of various types including people such as 121; items such as 122, or any real or simulated item that conventionally are shown in videos or television.

The people in the videos may be models or other celebrities or normal people.

The user interface 130 can control interaction with the video. The user interface can be a trackball that can include a trackball or mouse 131, or any other way of selecting areas on the screen. The user interface 130 can be a conventional remote control, e.g., for control only, or it can include a processor. One of the processors within the system, either the processor 105, or a processor in some other place, may carry out the steps described herein and shown with reference to the hardware of FIG. 2.

According to an embodiment, the client is an Apple computer-based device such as the iPad, iPhone, or iPad touch. However, this can also be done under Windows and OSX platforms. The information that is sent to the customer's includes either a live video feed or video file. The live video may be uncompressed HD-SDI 1080i 59.97fps or a lower standard.

FIG. 2 shows the hardware making up the device. a video source 200, is, as described above, either a video feed or a video file. If a live video feed, it can be in the form of uncompressed HD-SDI 1080i 59.97fps or a lower standard.

The video data 205 output from the video source is encoded by an encoder 210. The encoder allows the conversion and compression of analog or digital video into a single common format TCP/IP layered stream capable of transmission across wired and wireless networks.

The encoded video is sent by wireless transmitter 220 of a type that has the ability to transmit TCP/IP packets containing compressed video and audio information. By using 802.11g direct sequence spread spectrum signaling at 2.4 GHz, interference is avoided with a theoretical maximum throughput of 54 Mbit/s. Of course, alternative forms of wireless transmission can be used. The wireless transmissions to a wireless receiver 230 which receives and forwards the TCP/IP packets containing compressed video and audio information. The space between the wireless transmitter and the wireless receiver shown as 225 can be any channel. For example, this can be a transmission over WiMAX or over some other type channel.

The data received from the wireless receiver is sent to a CPE which is Device that permits the conversion and routing of local network traffic and data to the public internet. A transcoder is also attached to the Internet, and receives the data, in terms of packets. The packet data is then transformed into a single video stream format having multi-format data streams suitable for redistribution, and sent to a content delivery device 270 which is a mechanism composed of multiple servers and computer devices facilitating the distribution of one stream of data to many simultaneous streams for distribution to multiple sources and play back devices.

The different devices are also shown in FIG. 2 including a playback device 280 which is an appliance that can decode and display encoded compressed content for further conversion. The device plays back the information to a re-coder 285 that re encodes a previously encoded video and audio stream for use on a television network or system. This is then played over the network on a channel, for example as described above, channel 250.

Other information which can be connected directly to the content delivery network include a mobile device at 295 and/or to a PC at 296.

The path of the video content is designed to overcome bandwidth and data limitations.

A first example of a proven example stream path follows:

The original 1080i 59.97fps video signal is captured, encoded and compressed. The compressed stream is duplicated and delivered at 200 kb/s and 750 kb/s across the wireless link to a 5 Mb/s synchronous internet connection. The dual stream is delivered to the Amazon EC2 instance in Los Angeles and transcoded via the Wowza server to High and Low Flash stream for computer viewers and a Quicktime Stream for IPhone/iPad users. A high quality stream is also delivered to the ingress node at Oceanic Cable Hawaii where it is unconverted to an MPEG video feed and dropped into the Time Warner TV network for distribution across the island chain.

A second proven example delivery scenario follows:

Mobile: Stream is delivered as a direct H.264 QT encode to the iPhone or iPad, no 3-party player is required by the end user. The user simply clicks on the link provided on event page from their browser. Use can view over ATT 3G network or WiFi.

Computer: With over 98.9% of PC users having Flash Player installed on their computer the stream is viewable as an H.264Flash Video stream within the event website window, with the ability for the user to enable full screen mode.

TV: The end user turns their television to channel 250 or HD 1250 on Oceanic Time Warner to view the live video.

An advantage of this system is the major number of different elements which can be separated from one another. The distance 225, is between the wireless transmitter 220 and its receiver 230. There can be a second distance between the CPE 240 and the transcoder 260. Finally, the content delivery network 270 can be separated from the playback device.

Moreover, the different parts of the video source can be sent over different channels, e.g., as packets over the channel.

Other embodiments are contemplated.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of sending and receiving information can be used. The “metadata” that is used according to the present system can be any stream of information that is associated with the video, e.g., a separate stream of information, or a stream of information that is encoded into the data. This system can use cross platform distribution, simultaneous cross platform distribution, multi platforms (android). It can be used with a touch screen and/or a key pad remote.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
an encoder, receiving video from a video source, and converting said video into a single common format TCP/IP layered stream;
a wireless transmitter, receiving said TCP/IP layered stream and transmitting said layered stream as a wireless transmission;
a wireless receiver, receiving said wireless transmission, and forwarding said layered stream, still in a TCP/IP form, over the Internet; and
a transcoder, connected to the internet, and receiving said layered stream, and producing an output indicative of video, said output being in multiple different formats, a first of said formats being a format to a television, and a second of said formats being a format for direct connection to a mobile device.

2. A system as in claim 1 wherein said first of said formats is a coded format representing at least one of the plurality of channels on a television.

3. A method, comprising:
receiving video from a video source, and converting said video into a single common format TCP/IP layered stream;
receiving said TCP/IP layered stream and transmitting said layered stream as a wireless transmission;
receiving said wireless transmission, and forwarding said layered stream, still in a TCP/IP form, over the Internet; and
receiving said layered stream over the internet, and producing an output indicative of video, said output being in multiple different formats, a first of said formats being a format to a television, and a second of said formats being a format for direct connection to a mobile device.

4. A method as in claim 3, wherein said first of said formats is a coded format representing at least one of the plurality of channels on a television.
